(19) United States
(12) Patent Application Publication
(10) Pub. No.: US 2022/0147429 A1
(43) Pub. Date: May 12, 2022

(54) COMPONENT-BASED WEB PERFORMANCE MEASUREMENT

(71) Applicant: MICRO FOCUS LLC, Santa Clara, CA (US)

(72) Inventors: Er-Xin Shang, Shanghai (CN); Wen-Jie Qian, Shanghai (CN); Jason Yu, Shanghai (CN)

(21) Appl. No.: 17/094,299

(22) Filed: Nov. 10, 2020

(51) Int. Cl. G06F 11/34; G06F 11/30; G06F 11/32; G06F 16/957

(52) U.S. Cl. CPC G06F 11/3409; G06F 11/3075; G06F 16/957; G06F 11/3006; G06F 11/324

(57) ABSTRACT

Embodiments of the disclosure provide systems and methods for measuring performance of a web page and elements of the web page. According to one embodiment, web page performance measurement can comprise initiating measurement of performance of a web page rendered by a client device. The web page can comprise a plurality of elements and the plurality of elements can comprise at least one Web Component element. Performance of the web page can be monitored based on interaction with the client device and one or more performance metrics for each of the elements of the web page receive can be received from the client device. A set of performance metrics for the web page can be maintained. The set of performance metrics can comprise server-side performance metrics based on the monitoring of the performance of the web page and client-side performance metrics received from the client device.

### FIELD OF THE DISCLOSURE

Embodiments of the present disclosure relate generally to methods and systems for measuring performance of a web page and more particularly to measuring performance of a web page and individual elements of the web page on the server side as well as the client side.

### BACKGROUND

Present approaches to web page performance measurement are mainly based on network traffic statistics and the client-side response time measurements. These response measurements either focus on providing a report for a web page as a whole or focus on breaking down the response time measurements for smaller resource items. A downside to relying solely on client-side response measurements is that the results do not directly provide a measurement of performance relative to the individual features of web pages. Most of the time the developers would be more interested to know the performance of a specific feature rather than the traditional information provided by typical response time measurements. For example, a developer may want to know how well a login control works, how long the control will be displayed, how many times the login control needs to start in response to user actions, etc. This kind of information is not effectively measured or conveyed to the developer using traditional response time measurements.

The limitations of current approaches to measuring web page performance will likely become more pronounced as web technologies evolve. For example, Web Component technology provides a set of web platform Application Program Interfaces (APIs) that allow developers to create new, reusable, encapsulated elements to use in web pages and web applications. Using Web Components, different features of a website will be separated into different kinds of Web Components contained in separate, encapsulated elements of web pages. Current performance measurement tools do not provide component-based performance measurements thus limiting their usefulness for testing of web pages using Web Component technologies. Hence, there is a need for improved methods and systems for measuring performance of a web page.

### BRIEF SUMMARY

Embodiments of the disclosure provide systems and methods for measuring performance of a web page and individual elements of the web page on the server side as well as the client side. According to one embodiment, a method for web page performance measurement can comprise initiating, by a web server, measurement of performance of a web page rendered by a client device. Initiating the measurement of performance of the web page can comprise a request to initiate the test, the request indicating the web page, and providing the web page to the client device. The web page can comprise a plurality of elements and the plurality of elements can comprise at least one Web Component element.

The web server can monitor performance of the web page based on interaction with the client device and receive, from the client device, one or more performance metrics for each of the plurality of elements of the web page and maintain a set of performance metrics for the web page. The set of performance metrics can comprise one or more server-side performance metrics based on the monitoring of the performance of the web page and one or more client-side performance metrics for each of the plurality of elements of the web page received from the client device. The server-side performance metrics can comprise response times measured during execution of a test of the web page on the client device. The client-side performance metrics can comprise response times for each of the plurality of elements of the web page measured by monitor agent code executed by the client device during execution of a test of the web page on client device. The one or more client-side performance metrics for each of the plurality of elements of the web page can further comprise a list of elements of the plurality of elements of the web page. The list of elements can represent navigation through the web page during execution of a test of the web page on the client device.

In some cases, the web server can perform a replay function using the client-side performance metrics. The replay function can recreate at least a portion of the test of the web page and can comprise receiving, by the web server, an indication of a target element of the plurality of elements of the web page. The replay function can recreate navigation to the target element during execution of the test of the web page. The web server can trace a route through one or more other elements of the plurality of elements of the web page from the target element to a top-level element of the plurality of elements of the web page using the list of elements from the client-side performance metrics and replay transitions along the route from the top-level element to the target element.

The list of elements can be filtered to comprise only Web Component elements. In such cases, the web server can further perform an element replacement process on the web page. The element replacement process can comprise receiving information indicating a location on the web page, identifying a possible target element of the plurality of elements of the web page based on the information indicating the location on the web page, and determining whether the identified possible target is attached with a Shadow Document Object Model (DOM). In response to determining the identified possible target is not attached with a Shadow DOM, the web server can identify another possible target element of the plurality of elements of the web page based on the filtered list of elements and determine whether the identified possible target is attached with a Shadow DOM. In response to determining the identified possible target is attached with a Shadow DOM, the identified possible target can be replaced.

According to another embodiment, a method for web page performance measurement can comprise receiving, by a client device, from a web server, a web page comprising a plurality of elements. The plurality of elements can comprise at least one Web Component element. One or more tests can be executed on the web page by the client device. A monitor agent can also be inserted into the web page and executed by the client device. The monitor agent can collect one or more client-side performance metrics for each of the plurality of elements of the web page during execution of the one or more tests. For example, the monitor agent can collect the one or more client-side performance metrics for each of the plurality of elements of the web page by detecting a Document Object Model (DOM) event for an element of the plurality of elements of the web page, obtaining a queue representing a sequence of elements of the plurality of elements of the web page active before the detected DOM event, and filtering the obtained queue based on an element type, e.g., wherein the filtered queue contains only Web Component elements, and saving the filtered queue as part of the performance metrics for the element for which the DOM event was detected. The client-side performance metrics can comprise, for example, response times for each of the plurality of elements of the web page measured by the monitor agent code during execution of a test of the web page on client device and a list of elements of the plurality of elements of the web page. The list of elements can represent navigation through the web page during execution of a test of the web page on the client device. The client device can provide, to the web server, the collected one or more performance metrics for the plurality of elements of the web page.

According to yet another embodiment, a system can comprise a processor and a memory coupled with and reasonably by the processor and storing therein a set of instructions which, when executed by the processor, causes the processor to measure web page performance by initiating measurement of performance of a web page rendered by a client device. The web page can comprise a plurality of elements and the plurality of elements can comprise at least one Web Component element. Initiating the measurement of performance of the web page can comprise a request to initiate the test, the request indicating the web page, and providing the web page to the client device. The web page can comprise a plurality of elements and the plurality of elements can comprise at least one Web Component element.

The instructions can further cause the processor to monitor performance of the web page based on interaction with the client device and receive, from the client device, one or more performance metrics for each of the plurality of elements of the web page and maintain a set of performance metrics for the web page. The set of performance metrics can comprise one or more server-side performance metrics based on the monitoring of the performance of the web page and one or more client-side performance metrics for each of the plurality of elements of the web page received from the client device. The server-side performance metrics can comprise response times measured during execution of a test of the web page on the client device. The client-side performance metrics can comprise response times for each of the plurality of elements of the web page measured by monitor agent code executed by the client device during execution of a test of the web page on client device. The one or more client-side performance metrics for each of the plurality of elements of the web page can further comprise a list of elements of the plurality of elements of the web page. The list of elements can represent navigation through the web page during execution of a test of the web page on the client device.

In some cases, the instructions can cause the processor to perform a replay function using the client-side performance metrics. The replay function can recreate at least a portion of the test of the web page and can comprise receiving an indication of a target element of the plurality of elements of the web page. The replay function can recreate navigation to the target element during execution of the test of the web page. The instructions can cause the processor to trace a route through one or more other elements of the plurality of elements of the web page from the target element to a top-level element of the plurality of elements of the web page using the list of elements from the client-side performance metrics and replay transitions along the route from the top-level element to the target element.

The list of elements can be filtered to comprise only Web Component elements. In such cases, the instructions can further cause the processor to perform an element replacement process on the web page. The element replacement process can comprise receiving information indicating a location on the web page, identifying a possible target element of the plurality of elements of the web page based on the information indicating the location on the web page, and determining whether the identified possible target is attached with a Shadow Document Object Model (DOM). In response to determining the identified possible target is not attached with a Shadow DOM, the instructions can cause the processor to identify another possible target element of the plurality of elements of the web page based on the filtered list of elements and determine whether the identified possible target is attached with a Shadow DOM. In response to determining the identified possible target is attached with a Shadow DOM, the identified possible target can be replaced.

### BRIEF DESCRIPTION OF THE DRAWINGS

FIG. 1 is a block diagram illustrating elements of an exemplary computing environment in which embodiments of the present disclosure may be implemented.

FIG. 2 is a block diagram illustrating elements of an exemplary computing device in which embodiments of the present disclosure may be implemented.

FIG. 3 is a block diagram illustrating components of an exemplary environment for measuring performance of a web page according to one embodiment of the present disclosure.

FIG. 4 is a flowchart illustrating an exemplary processor for measuring performance of a web page according to one embodiment of the present disclosure.

FIG. 5 is a flowchart illustrating an exemplary record process according to one embodiment of the present disclosure.

FIG. 6 is a flowchart illustrating an exemplary session replay process according to one embodiment of the present disclosure.

FIG. 7 is a flowchart illustrating an exemplary element replacement process according to one embodiment of the present disclosure.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

In the following description, for the purposes of explanation, numerous specific details are set forth in order to provide a thorough understanding of various embodiments disclosed herein. It will be apparent, however, to one skilled in the art that various embodiments of the present disclosure may be practiced without some of these specific details. The ensuing description provides exemplary embodiments only and is not intended to limit the scope or applicability of the disclosure. Furthermore, to avoid unnecessarily obscuring the present disclosure, the preceding description omits a number of known structures and devices. This omission is not to be construed as a limitation of the scopes of the claims. Rather, the ensuing description of the exemplary embodiments will provide those skilled in the art with an enabling description for implementing an exemplary embodiment. It should however be appreciated that the present disclosure may be practiced in a variety of ways beyond the specific detail set forth herein.

While the exemplary aspects, embodiments, and/or configurations illustrated herein show the various components of the system collocated, certain components of the system can be located remotely, at distant portions of a distributed network, such as a Local-Area Network (LAN) and/or Wide-Area Network (WAN) such as the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the following description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, Non-Volatile Random-Access Memory (NVRAM), or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a Compact Disk Read-Only Memory (CD-ROM), any other optical medium, punch cards, paper tape, any other physical medium with patterns of holes, a Random-Access Memory (RAM), a Programmable Read-Only Memory (PROM), and Erasable Programmable Read-Only Memory (EPROM), a Flash-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

A “computer readable signal” medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, Radio Frequency (RF), etc., or any suitable combination of the foregoing.

The terms “determine,” “calculate,” and “compute,” and variations thereof, as used herein, are used interchangeably and include any type of methodology, process, mathematical operation or technique.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as Programmable Logic Device (PLD), Programmable Logic Array (PLA), Field Programmable Gate Array (FPGA), Programmable Array Logic (PAL), special purpose computer, any comparable means, or the like. In general, any device(s) or means capable of implementing the methodology illustrated herein can be used to implement the various aspects of this disclosure. Exemplary hardware that can be used for the disclosed embodiments, configurations, and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or Very Large-Scale Integration (VLSI) design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or Common Gateway Interface (CGI) script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

Various additional details of embodiments of the present disclosure will be described below with reference to the figures. While the flowcharts will be discussed and illustrated in relation to a particular sequence of events, it should be appreciated that changes, additions, and omissions to this sequence can occur without materially affecting the operation of the disclosed embodiments, configuration, and aspects.

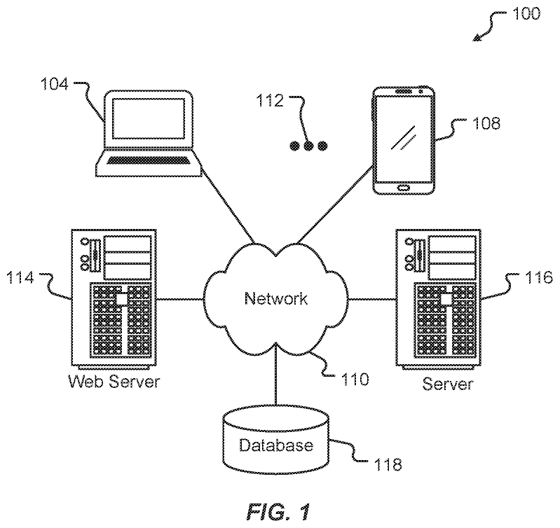

FIG. 1 is a block diagram illustrating elements of an exemplary computing environment in which embodiments of the present disclosure may be implemented. More specifically, this example illustrates a computing environment 100 that may function as the servers, user computers, or other systems provided and described herein. The environment 100 includes one or more user computers, or computing devices, such as a computing device 104, a communication device 108, and/or more 112. The computing devices 104, 108, 112 may include general purpose personal computers (including, merely by way of example, personal computers, and/or laptop computers running various versions of Microsoft Corp.'s Windows® and/or Apple Corp.'s Macintosh® operating systems) and/or workstation computers running any of a variety of commercially-available UNIX® or UNIX-like operating systems. These computing devices 104, 108, 112 may also have any of a variety of applications, including for example, database client and/or server applications, and web browser applications. Alternatively, the computing devices 104, 108, 112 may be any other electronic device, such as a thin-client computer, Internet-enabled mobile telephone, and/or personal digital assistant, capable of communicating via a network 110 and/or displaying and navigating web pages or other types of electronic documents. Although the exemplary computer environment 100 is shown with two computing devices, any number of user computers or computing devices may be supported.

Environment 100 further includes a network 110. The network 110 may can be any type of network familiar to those skilled in the art that can support data communications using any of a variety of commercially-available protocols, including without limitation Session Initiation Protocol (SIP), Transmission Control Protocol/Internet Protocol (TCP/IP), Systems Network Architecture (SNA), Internetwork Packet Exchange (IPX), AppleTalk, and the like. Merely by way of example, the network 110 maybe a Local Area Network (LAN), such as an Ethernet network, a Token-Ring network and/or the like; a wide-area network; a virtual network, including without limitation a Virtual Private Network (VPN); the Internet; an intranet; an extranet; a Public Switched Telephone Network (PSTN); an infra-red network; a wireless network (e.g., a network operating under any of the IEEE 802.9 suite of protocols, the Bluetooth® protocol known in the art, and/or any other wireless protocol); and/or any combination of these and/or other networks.

The system may also include one or more servers 114, 116. In this example, server 114 is shown as a web server and server 116 is shown as an application server. The web server 114, which may be used to process requests for web pages or other electronic documents from computing devices 104, 108, 112. The web server 114 can be running an operating system including any of those discussed above, as well as any commercially-available server operating systems. The web server 114 can also run a variety of server applications, including SIP servers, HyperText Transfer Protocol (secure) (HTTP(s)) servers, FTP servers, CGI servers, database servers, Java servers, and the like. In some instances, the web server 114 may publish operations available operations as one or more web services.

The environment 100 may also include one or more file and or/application servers 116, which can, in addition to an operating system, include one or more applications accessible by a client running on one or more of the computing devices 104, 108, 112. The server(s) 116 and/or 114 may be one or more general purpose computers capable of executing programs or scripts in response to the computing devices 104, 108, 112. As one example, the server 116, 114 may execute one or more web applications. The web application may be implemented as one or more scripts or programs written in any programming language, such as Java™, C, C#®, or C++, and/or any scripting language, such as Perl, Python, or Tool Command Language (TCL), as well as combinations of any programming/scripting languages. The application server(s) 116 may also include database servers, including without limitation those commercially available from Oracle®, Microsoft®, Sybase®, IBM® and the like, which can process requests from database clients running on a computing device 104, 108, 112.

The web pages created by the server 114 and/or 116 may be forwarded to a computing device 104, 108, 112 via a web (file) server 114, 116. Similarly, the web server 114 may be able to receive web page requests, web services invocations, and/or input data from a computing device 104, 108, 112 (e.g., a user computer, etc.) and can forward the web page requests and/or input data to the web (application) server 116. In further embodiments, the server 116 may function as a file server. Although for ease of description, FIG. 1 illustrates a separate web server 114 and file/application server 116, those skilled in the art will recognize that the functions described with respect to servers 114, 116 may be performed by a single server and/or a plurality of specialized servers, depending on implementation-specific needs and parameters. The computer systems 104, 108, 112, web (file) server 114 and/or web (application) server 116 may function as the system, devices, or components described herein.

The environment 100 may also include a database 118. The database 118 may reside in a variety of locations. By way of example, database 118 may reside on a storage medium local to (and/or resident in) one or more of the computers 104, 108, 112, 114, 116. Alternatively, it may be remote from any or all of the computers 104, 108, 112, 114, 116, and in communication (e.g., via the network 110) with one or more of these. The database 118 may reside in a Storage-Area Network (SAN) familiar to those skilled in the art. Similarly, any necessary files for performing the functions attributed to the computers 104, 108, 112, 114, 116 may be stored locally on the respective computer and/or remotely, as appropriate. The database 118 may be a relational database, such as Oracle 20i®, that is adapted to store, update, and retrieve data in response to Structured Query Language (SQL) formatted commands.

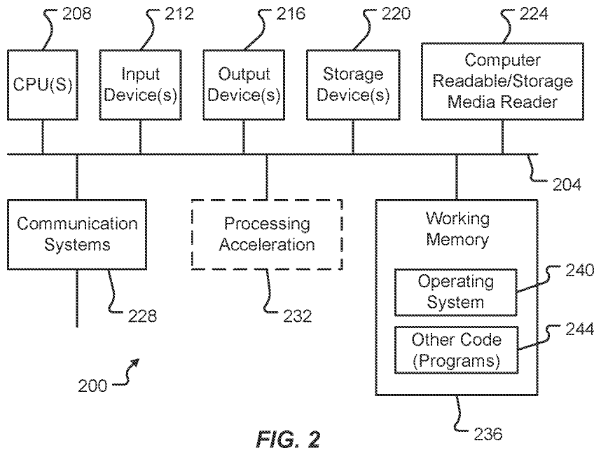

FIG. 2 is a block diagram illustrating elements of an exemplary computing device in which embodiments of the present disclosure may be implemented. More specifically, this example illustrates one embodiment of a computer system 200 upon which the servers, user computers, computing devices, or other systems or components described above may be deployed or executed. The computer system 200 is shown comprising hardware elements that may be electrically coupled via a bus 204. The hardware elements may include one or more Central Processing Units (CPUs) 208; one or more input devices 212 (e.g., a mouse, a keyboard, etc.); and one or more output devices 216 (e.g., a display device, a printer, etc.). The computer system 200 may also include one or more storage devices 220. By way of example, storage device(s) 220 may be disk drives, optical storage devices, solid-state storage devices such as a Random-Access Memory (RAM) and/or a Read-Only Memory (ROM), which can be programmable, flash-updateable and/or the like.

The computer system 200 may additionally include a computer-readable storage media reader 224; a communications system 228 (e.g., a modem, a network card (wireless or wired), an infra-red communication device, etc.); and working memory 236, which may include RAM and ROM devices as described above. The computer system 200 may also include a processing acceleration unit 232, which can include a Digital Signal Processor (DSP), a special-purpose processor, and/or the like.

The computer-readable storage media reader 224 can further be connected to a computer-readable storage medium, together (and, optionally, in combination with storage device(s) 220) comprehensively representing remote, local, fixed, and/or removable storage devices plus storage media for temporarily and/or more permanently containing computer-readable information. The communications system 228 may permit data to be exchanged with a network and/or any other computer described above with respect to the computer environments described herein. Moreover, as disclosed herein, the term “storage medium” may represent one or more devices for storing data, including ROM, RAM, magnetic RAM, core memory, magnetic disk storage mediums, optical storage mediums, flash memory devices and/or other machine-readable mediums for storing information.

The computer system 200 may also comprise software elements, shown as being currently located within a working memory 236, including an operating system 240 and/or other code 244. It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed.

Examples of the processors 208 as described herein may include, but are not limited to, at least one of Qualcomm® Snapdragon® 800 and 801, Qualcomm® Snapdragon® 620 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

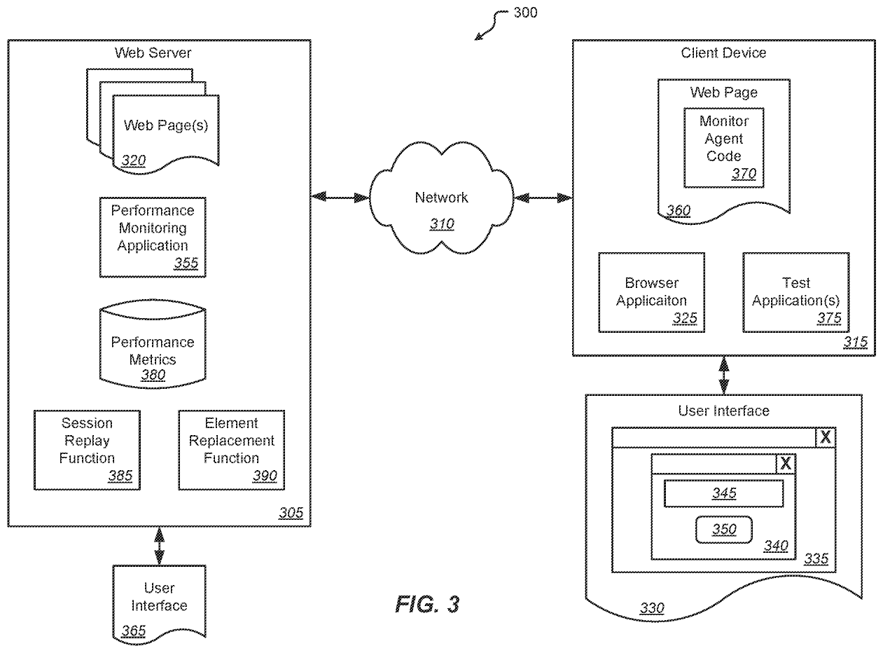

FIG. 3 is a block diagram illustrating components of an exemplary environment for measuring performance of a web page according to one embodiment of the present disclosure. As illustrated in this example, the environment 300 can comprise a web server 305 such as described above communicatively coupled with one or more communications networks 310 including any one or more wired and/or wireless local and/or wide area networks as also described above. The environment 300 can also comprise a client device 315 communicatively coupled with the communications network(s) 310. The client device 315 can comprise any of a variety of computing devices such as described above.

Generally speaking, the web server 305 can maintain a set of web pages 320 to be provided to the client device 315 over the communications network(s) 310 as known in the art. Also as known in the art, the client device 315 can execute a browser application 325 which can receive and render the web pages 320 as a user interface 330. The user interface 330 can include a number of elements 335-350 and some of the elements 340, 345 and 350 can comprise Web Component elements.

According to one embodiment, the web server 305 can execute a performance monitoring application 355. Generally speaking, the web performance monitoring application 355 can monitor and measure the performance of a web page 360 rendered on the client device. The performance monitoring application 355 can also provide a user interface 365 through which a user can interact with the performance monitoring application 355, for example, to select a web page 320 to be tested, review results, etc.

More specifically, the performance monitoring application 355 can initiate performance measurement of a web page 320 in response to receiving an indication of a web page 320 to test. The received indication can be generated automatically, e.g., by a test application or script, or as a result of a tester of another user clicking a link to the web page, e.g., in the user interface 365 provided by the performance monitoring application 355, or otherwise selecting the web page to be tested.

The client device 315 can also execute one or more test applications 375. The test application(s) 375 can manipulate the provided web page 360 rendered by the browser application 325. In other cases, a test may be conducted in whole or in part based on input from a tester or another user through the user interface 330 when the provided web page 360 is rendered by the browser application 325. The test applications 375 can also insert monitor agent code 370 into the received web page 360. Generally speaking, and as will be described in greater detail below, the monitor agent code 370 can cause the client device to collect and provide a set of client-side metrics for the provided web page 360 when one or more tests are executed on the web page 360 on the client device 315. During execution of tests on the web page 360 by the client device 315, and more specifically by the client device 315 executing the monitor agent code 370 during execution of the tests, the client device 315 can execute a record process to collect one or more client-side performance metrics for each of the plurality of elements 335-350 of the web page 360. For example, the monitor agent 370 can collect one or more client-side performance metrics for each of the plurality of elements 335-350 of the web page 360 by detecting a Document Object Model (DOM) event for an element of the plurality of elements 335-350 of the web page 360, obtaining a queue representing a sequence of elements of the plurality of elements 335 of the web page 360 active before the detected DOM event, and filtering the obtained queue based on an element type, e.g., wherein the filtered queue contains only Web Component elements. The filtered queue can be saved as part of the performance metrics for the element for which the DOM event was detected. The client-side performance metrics can comprise, for example, response times for each of the plurality of elements 335-350 of the web page 360 measured by the monitor agent code 370 during execution of a test of the web page 360 on the client device 315 and the filtered queue as a list of elements of the plurality of elements 335-350 of the web page 360. The list of elements can represent navigation through the web page 360 during execution of a test application 375 of the web page 360 on the client device 315. In some cases, the monitor agent 370 executing on the client device 315 can also calculate a nested level, i.e., a hierarchical depth, for each element of the list of elements. The client device 315 can provide, to the web server 305, the collected one or more performance metrics for the plurality of elements 335-350 of the web page 360.

During execution of the test application(s) 375 by the client device 315, the performance monitoring application 355 executing on the web server 305 can also monitor performance of the web page 360 based on interaction with the client device 315. The server-side performance metrics can comprise response times measured during execution of a test of the web page 360 on the client device 315. The web server 305 can also receive, from the client device 315, the one or more client-side performance metrics for the elements of the web page and maintain a set of performance metrics 380 for the web page 360. The maintained set of performance metrics 380, i.e., the server-side metrics collected by the performance monitoring application 355 of the web server 315 as well as the client-side metrics collected by the monitoring agent 370 and received from the client device 315, can be utilized to perform a variety of additional processes including, but not limited to a session replace process and/or an element replacement process.

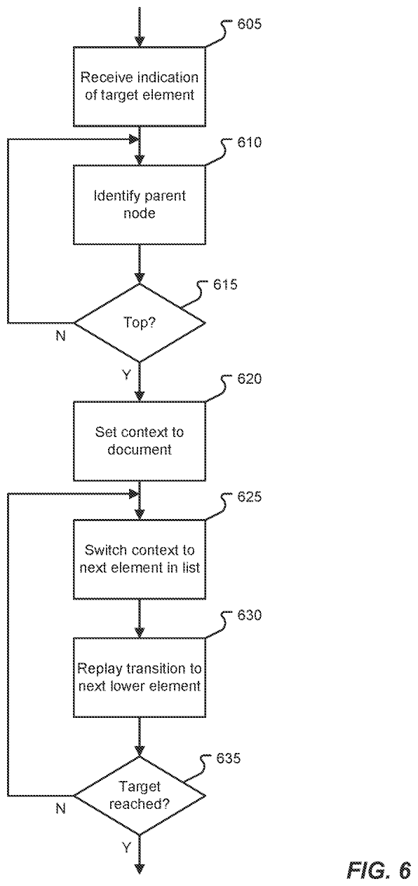

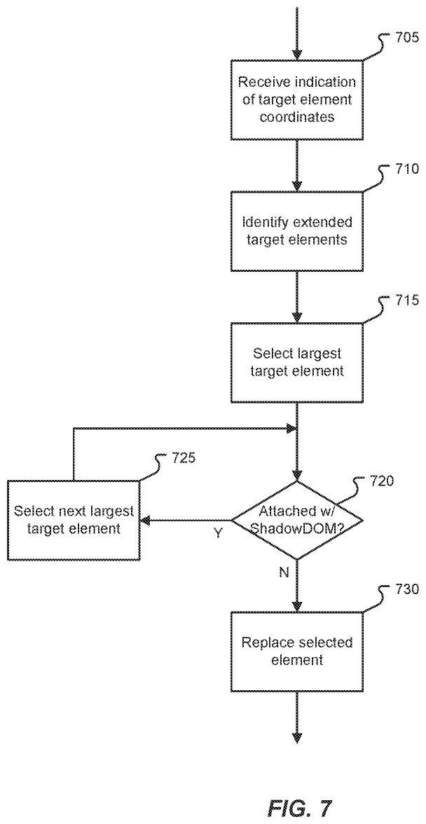

For example, a session replay function 385 of the web server 305 can be used by the performance metrics 380 to recreate at least a portion of the test of the web page 360, i.e., replay navigation through a number of elements of the web page while the test is being executed. Generally speaking, the session replay function 385 can trace a route through one or more other elements of the plurality of elements 335-350 of the web page 360 from the target element to a top-level element of the plurality of elements of the web page using the list of elements from the client-side performance metrics and replay transitions along the route from the top-level element to the target element. Additional details of an exemplary session replay function 385 will be described below with reference to FIG. 6. The web server 305 can further perform an element replacement function 390 on the web page 360. Generally speaking, the element replacement function 390 can allow a developer or another user to select one of the elements 335-350 of the web page 360 to be replaced, e.g., based on a review the maintained performance metrics 380. Additional details of an exemplary element replacement function 390 will be described below with reference to FIG. 7.

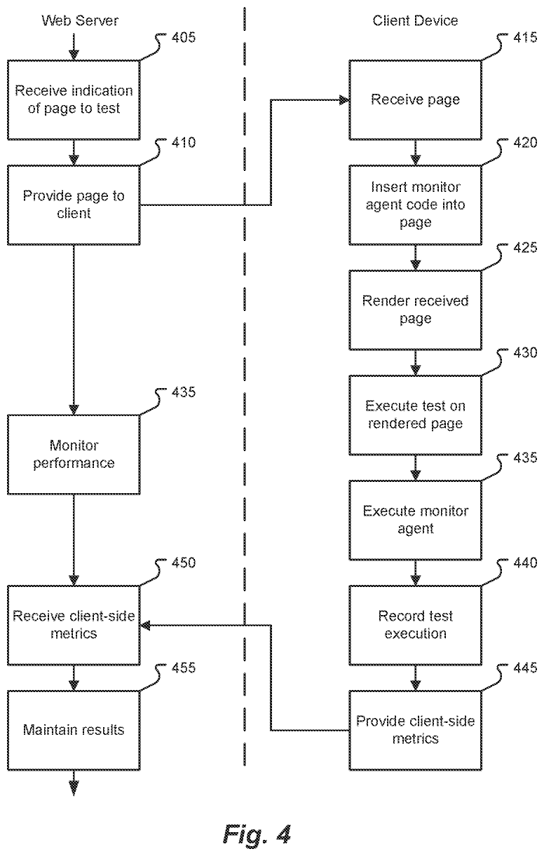

FIG. 4 is a flowchart illustrating an exemplary processor for measuring performance of a web page according to one embodiment of the present disclosure. As illustrated in this example, measuring performance of a web page 360 can comprise initiating 405-415, by the web server 305, measurement of performance of a web page 360 comprising a plurality of elements 335-350 to be rendered by the client device 315. The plurality of elements 335-350 can comprise at least one Web Component element. Initiating 405-415 the measurement of performance of the web page 360 can comprise receiving 405 an indication of a web page 360 to test. The received 405 indication can be generated automatically, e.g., by a test application or script, or as a result of a tester of another user clicking a link to the web page 360 or otherwise selecting the web page 360 to be tested. Also as illustrated here, initiating 405-415 the measurement of performance of the web page 360 can comprise receiving, by the web server 305, an indication of the web page to be tested, e.g., by receiving a request to initiate the test, the request indicating the web page, and providing 410 the web page to the client device 315.

The client device 315 can receive 415, from the web server 305, the web page 360 and insert 420 monitor agent code 370 into the web page 360. As noted above, the monitor agent code 370 can cause the client device 315 to collect and provide a set of client-side metrics for the provided 415 web page 360 when one or more tests are executed on the web page 360 on the client device 315. The client device 315 can then render 425 the received web page 360, e.g., via a browser application 325 or similar. One or more tests can be executed 430 on the web page 360 by the client device 315, e.g., automatically by a testing application or script or by navigation through the web page 360 by a tester or another user. The monitor agent can also be executed 435 by the client device 315. As noted above and as will be described in greater detail below, the monitor agent can execute a record process 440 to collect one or more client-side performance metrics for each of the plurality of elements 335-350 of the web page 360 during execution 430 of the one or more tests. The client-side performance metrics can comprise, for example, response times for each of the plurality of elements 335-350 of the web page 360 measured by the monitor agent code 370 during execution of a test of the web page 360 on client device 315 and a list of elements of the plurality of elements 335-350 of the web page 360. The list of elements can represent navigation through the web page 360 during execution of a test of the web page 360 on the client device 315. The client device 315 can provide 445, to the web server 305, the collected one or more performance metrics for the plurality of elements 335-350 of the web page 360.

During execution 430 of the tests by the client device 315, the web server 305 can also monitor 435 performance of the web page 360 based on interaction with the client device 315. The server-side performance metrics can comprise response times measured during execution of a test of the web page 360 on the client device 315. The web server 305 can also receive 450, from the client device 315, the one or more client-side performance metrics for the elements of the web page 360 and maintain 455 a set of performance metrics 380 for the web page 360. The maintained 455 set of performance metrics 380, i.e., the server-side metrics collected by the web server 305 as well as the client-side metrics received 450 from the client device 315, can be utilized to perform a variety of additional processes including, but not limited to a session replace process and/or an element replacement process as will be described in greater detail below.

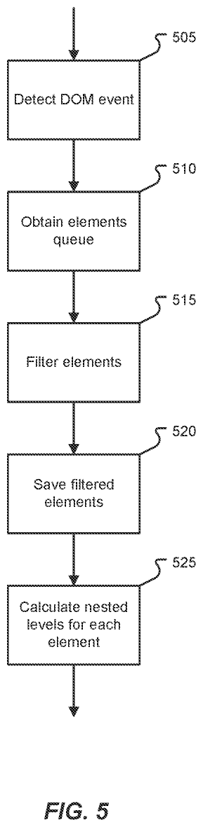

FIG. 5 is a flowchart illustrating an exemplary record process according to one embodiment of the present disclosure. As noted above, during execution of tests on the web page 360 by the client device 315, and more specifically by the client device 315 executing the monitor agent code 370 during execution of the tests, the client device 315 can execute a record process 440 to collect one or more client-side performance metrics for each of the plurality of elements 335-350 of the web page 360. Also as noted above, the plurality of elements 335-350 on the web page 360 can comprise at least one Web Component element. In such cases, the monitor agent can collect the one or more client-side performance metrics for each of the plurality of elements 335-350 of the web page 360 by detecting 505 a Document Object Model (DOM) event for an element of the plurality of elements 335-350 of the web page 360, obtaining 510 a queue representing a sequence of elements of the plurality of elements 335-350 of the web page 360 active before the detected DOM event, and filtering 515 the obtained queue based on an element type, e.g., wherein the filtered queue contains only Web Component elements. The filtered queue can be saved 520 as part of the performance metrics for the element for which the DOM event was detected. The client-side performance metrics can comprise, for example, response times for each of the plurality of elements 335-350 of the web page 360 measured by the monitor agent code 370 during execution of a test of the web page 360 on client device 315 and the filtered queue as a list of elements of the plurality of elements 335-350 of the web page 360. The list of elements can represent navigation through the web page 360 during execution of a test of the web page 360 on the client device 315. In some cases, the monitor agent executing on the client device 315 can also calculate 525 a nested level, i.e., a hierarchical depth, for each element of the list of elements. The client device 315 can provide, to the web server 305, the collected one or more performance metrics for the plurality of elements 335-350 of the web page 360 as described above.

FIG. 6 is a flowchart illustrating an exemplary session replay process according to one embodiment of the present disclosure. As noted above, the web server 305 can perform a number of additional functions using the saved server-side and/or client-side performance metrics. For example, a session replay function 385 can be used the performance metrics to recreate at least a portion of the test of the web page 360, i.e., replay navigation through a number of elements of the web page 360 while the test is being executed. Generally speaking, the replay process can trace a route through one or more other elements of the plurality of elements 335-350 of the web page 360 from the target element to a top-level element of the plurality of elements 335-350 of the web page 360 using the list of elements from the client-side performance metrics and replay transitions along the route from the top-level element to the target element.

More specifically, and as illustrated in this example, a session replay process can comprise receiving 605 an indication of a target element of the plurality of elements 335-350 of the web page 360, e.g., an automatic selection by a testing application or user selection made through a user interface. A parent node, i.e., a predecessor of the selected element from which navigation to the selected element occurred during the test, can be identified 610 in the list of elements from the client-side performance metrics. A determination 615 can then be made as to whether the identified parent is a top node in the list, i.e., the first element from which navigation started during the test. In response to determining 615 that the identified parent is not the top node in the list, a parent of that node, i.e., the next predecessor in the list of elements from the client-side performance metrics, can be identified 610. This process of tracing the route through the elements of web page 360 from the target element to a top-level element of the plurality of elements 335-350 of the web page 360 using the list of elements from the client-side performance metrics can continue until a determination 615 is made that the top element has been identified.

In response to determining 615 that the top element in the list of elements from the client-side performance metrics has been identified, a context for the web page 360 can be set 620 to document and the context can then be switched 625 to the next element in the list of elements from the client-side performance metrics. For the first iteration, this would be the top element in the list. While, or in addition to, switching 625 the context, the transition to the next element can be replayed 630, i.e., rendered on a browser etc. A determination 635 can then be made as to whether the target element has been reached, i.e., whether the current context is set to the target element. In response to determining 635 the target element has not been reached, switching 625 the context to the next element in the list of elements from the client-side performance metrics and replaying that transition can continue until a determination 635 is made that the target has been reached.

FIG. 7 is a flowchart illustrating an exemplary element replacement process according to one embodiment of the present disclosure. As noted above, the list of elements generated by the monitor agent and provided with the client-side performance metrics can be filtered to comprise only Web Component elements. In such cases, the web server 305 can further perform an element replacement process on the web page 360. As illustrated in this example, the element replacement process can comprise receiving 705 information indicating a location on the web page 360, e.g., a set of coordinates, such as x,y coordinates, on the rendered web page 360, received in response to a developer or another user manipulating a mouse or other pointing device to position a cursor or other pointer on an element on the web page 360 and clicking or otherwise selecting the location. A possible target element of the plurality of elements 335-350 of the web page 360 can be identified based on the information indicating the location on the web page 360 by identifying 710 extended target elements surrounding the location indicated by the received information and selecting 715 the largest of the extended target elements. A determination 720 can be made as to whether the identified possible target is attached with a Shadow Document Object Model (DOM). In response to determining 720 the identified possible target is not attached with a Shadow DOM, the web server 305 can select 725 another possible target element of the plurality of elements 335-350 of the web page 360 based on the filtered list of elements and determine whether the identified possible target is attached with a Shadow DOM. In response to determining 720 the identified possible target is attached with a Shadow DOM, the identified possible target can be replaced 730.

The present disclosure, in various aspects, embodiments, and/or configurations, includes components, methods, processes, systems, and/or apparatus substantially as depicted and described herein, including various aspects, embodiments, configurations embodiments, sub-combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method for web page performance measurement, the method comprising:
initiating, by a web server, measurement of performance of a web page rendered by a client device, the web page comprising a plurality of elements, the plurality of elements comprising at least one Web Component element;
monitoring, by the web server, performance of the web page based on interaction with the client device;
receiving, by the web server, from the client device, one or more performance metrics for each of the plurality of elements of the web page; and
maintaining, by the web server, a set of performance metrics for the web page, the set of performance metrics comprising one or more server-side performance metrics based on the monitoring of the performance of the web page and one or more client-side performance metrics for each of the plurality of elements of the web page received from the client device.

2. The method of claim 1, wherein initiating the measurement of performance of the web page comprises:
receiving, by the web server, a request to initiate the test, the request indicating the web page; and
providing, by the web server, the web page to the client device.

3. The method of claim 1, wherein the server-side performance metrics comprises response times measured during execution of a test of the web page on the client device.

4. The method of claim 1, wherein the client-side performance metrics comprises response times for each of the plurality of elements of the web page measured by monitor agent code executed by the client device during execution of a test of the web page on client device.

5. The method of claim 1, wherein the one or more client-side performance metrics for each of the plurality of elements of the web page comprise a list of elements of the plurality of elements of the web page, the list of elements representing navigation through the web page during execution of a test of the web page on the client device.

6. The method of claim 5, further comprising performing, by the web server, a replay function using the client-side performance metrics, the replay function recreating at least a portion of the test of the web page and comprising:
receiving, by the web server, an indication of a target element of the plurality of elements of the web page, wherein the replay functions recreates navigation to the target element during execution of the test of the web page;
tracing, by the web server, a route through one or more other elements of the plurality of elements of the web page from the target element to a top-level element of the plurality of elements of the web page using the list of elements from the client-side performance metrics; and
replaying, by the web server, transitions along the route from the top-level element to the target element.

7. The method of claim 5, wherein the list of elements is filtered to comprise only Web Component elements.

8. The method of claim 6, further comprising performing, by the web server, an element replacement process on the web page, the element replacement process comprising:
receiving, by the web server, information indicating a location on the web page;
identifying, by the web server, a possible target element of the plurality of elements of the web page based on the information indicating the location on the web page;
determining, by the web server, whether the identified possible target is attached with a Shadow Document Object Model (DOM);
in response to determining the identified possible target is not attached with a Shadow DOM, identifying, by the web server, another possible target element of the plurality of elements of the web page based on the filtered list of elements and determining, by the web server, whether the identified possible target is attached with a Shadow DOM; and
in response to determining the identified possible target is attached with a Shadow DOM, replacing, by the web server, the identified possible target.

9. A method for web page performance measurement, the method comprising:
receiving, by a client device, from a web server, a web page comprising a plurality of elements, the plurality of elements comprising at least one Web Component element;
inserting, by a test application executing on the client device, monitor agent code into the web page, wherein the monitor agent code is executed by the client device and causes the client device to collect the one or more client-side performance metrics for each of the plurality of elements of the web page and provide the one or more client-side performance metrics for each of the plurality of elements of the web page to the web server; and
executing, by the client device, one or more tests on the web page;
executing, by the client device, the monitor agent, wherein the monitor agent collects one or more client-side performance metrics for each of the plurality of elements of the web page during execution of the one or more tests; and
providing, by the client device, to the web server, the collected one or more performance metrics for the plurality of elements of the web page.

10. The method of claim 9, wherein the monitor agent collects the one or more client-side performance metrics for each of the plurality of elements of the web page by:
detecting a Document Object Model (DOM) event for an element of the plurality of elements of the web page;
obtaining a queue representing a sequence of elements of the plurality of elements of the web page active before the detected DOM event;
filtering the obtained queue based on an element type, wherein the filtered queue contains only Web Component elements; and
saving the filtered queue as part of the performance metrics for the element for which the DOM event was detected.

11. The method of claim 9, wherein the client-side performance metrics comprises response times for each of the plurality of elements of the web page measured by the monitor agent code during execution of a test of the web page on client device and a list of elements of the plurality of elements of the web page.

12. The method of claim 11, wherein the list of elements represents navigation through the web page during execution of a test of the web page on the client device.

13. A system comprising:
a processor; and
a memory coupled with and reasonably by the processor and storing therein a set of instructions which, when executed by the processor, causes the processor to measure web page performance by:
initiating measurement of performance of a web page rendered by a client device, the web page comprising a plurality of elements, the plurality of elements comprising at least one Web Component element;
monitoring performance of the web page based on interaction with the client device;
receiving from the client device, one or more performance metrics for each of the plurality of elements of the web page; and
maintaining a set of performance metrics for the web page, the set of performance metrics comprising one or more server-side performance metrics based on the monitoring of the performance of the web page and one or more client-side performance metrics for each of the plurality of elements of the web page received from the client device.

14. The system of claim 13, wherein initiating the measurement of performance of the web page comprises:
receiving a request to initiate the test, the request indicating the web page; and
providing the web page to the client device.

15. The system of claim 13, wherein the server-side performance metrics comprises response times measured during execution of a test of the web page on the client device.

16. The system of claim 13, wherein the client-side performance metrics comprises response times for each of the plurality of elements of the web page measured by monitor agent code executed by the client device during execution of a test of the web page on client device.

17. The system of claim 13, wherein the one or more client-side performance metrics for each of the plurality of elements of the web page comprise a list of elements of the plurality of elements of the web page, the list of elements representing navigation through the web page during execution of a test of the web page on the client device.

18. The system of claim 17, wherein the instructions further cause the processor to perform a replay function using the client-side performance metrics, the replay function recreating at least a portion of the test of the web page and comprising:
receiving an indication of a target element of the plurality of elements of the web page, wherein the replay functions recreates navigation to the target element during execution of the test of the web page;
tracing a route through one or more other elements of the plurality of elements of the web page from the target element to a top-level element of the plurality of elements of the web page using the list of elements from the client-side performance metrics; and
replaying transitions along the route from the top-level element to the target element.

19. The system of claim 17, wherein the list of elements is filtered to comprise only Web Component elements.

20. The system of claim 18, wherein the instructions further cause the processor to perform an element replacement process on the web page, the element replacement process comprising:
receiving information indicating a location on the web page;
identifying a possible target element of the plurality of elements of the web page based on the information indicating the location on the web page;
determining whether the identified possible target is attached with a Shadow Document Object Model (DOM);
in response to determining the identified possible target is not attached with a Shadow DOM, identifying another possible target element of the plurality of elements of the web page based on the filtered list of elements and determining whether the identified possible target is attached with a Shadow DOM; and
in response to determining the identified possible target is attached with a Shadow DOM, replacing the identified possible target.
